(19) United States
(12) Patent Application Publication
(10) Pub. No.: US 2025/0292961 A1
(43) Pub. Date: Sep. 18, 2025

(54) MULTILAYER CERAMIC CAPACITOR

(71) Applicant: TAIYO YUDEN CO., LTD., Tokyo (JP)

(72) Inventors: Riki SUEMASA, Takasaki-shi (JP); Hidetoshi MASUDA, Takasaki-shi (JP)

(21) Appl. No.: 19/224,514

(22) Filed: May 30, 2025

Related U.S. Application Data
(63) Continuation of application No. PCT/JP2023/043747, filed on Dec. 7, 2023.

(30) Foreign Application Priority Data
Dec. 27, 2022 (JP) 2022-210804

(51) Int. Cl. H01G 4/008; H01G 4/12; H01G 4/232; H01G 4/248; H01G 4/30

(52) U.S. Cl. CPC H01G 4/008; H01G 4/12; H01G 4/232; H01G 4/248; H01G 4/30

(57) ABSTRACT

A multilayer ceramic capacitor in an embodiment includes: a multilayer chip, having multiple dielectric layers formed by a dielectric ceramic, and internal electrodes respectively placed on the top and bottom faces of each of the dielectric layers, whose main component element is nickel and which further contain, by a total amount of more than 0% and no more than 10% by atom relative to nickel, at least two additive elements selected from a group that consists of metal elements that form an alloy together with nickel, and of silicon, wherein a pair of extraction faces are formed in a manner facing each other and having the internal electrodes alternately extracted to and exposed on the respective extraction faces; and external electrodes that electrically connect together the internal electrodes extracted onto the respective extraction faces of the multilayer chip.

### TECHNICAL FIELD

The present invention relates to a multilayer ceramic capacitor.

### BACKGROUND ART

The demand for high-end multilayer ceramic capacitors featuring high capacity and high reliability for use in onboard applications and mobile terminal applications is rising in recent years. Such multilayer ceramic capacitors are used in high-frequency circuits and power circuits for the purposes of DC decoupling, noise bypassing, voltage stabilization, and the like. These multilayer ceramic capacitors are facing calls for size reduction and capacity increase to meet the need for more added functions.

An effective way to reduce the size, while increasing the capacity, of a multilayer ceramic capacitor is to reduce its internal electrode layer thickness and increase the number of laminated layers. However, reducing the internal electrode layer thickness can cause the capacitance of the multilayer ceramic capacitor to drop. This is because the metal by which the internal electrodes are formed shrinks when the dielectric layers and internal electrodes are fired as one piece, thereby causing discontinuity in the internal electrodes.

As a scheme to inhibit discontinuity in the internal electrodes of a multilayer ceramic capacitor, Patent Literature 1 discloses an art of forming dielectric layers of a specific compositional makeup in combination with internal electrodes containing ZrO₂ or TiO₂.

Additionally, Patent Literature 2 discloses an art of using, as a metal powder for internal electrode paste, an Ni alloy powder containing 85.0 to 90.0% by mass of Ni along with Al and unavoidable impurities accounting for the rest, characterized in that the average particle size of the Ni alloy powder is 0.04 to 1.00 μm.

Furthermore, Patent Literature 3 discloses an art of using internal electrodes whose main component is Ni and which also contains Si, comprising an alloy region formed by an Ni—Si alloy and an alloy element region whose main component is Si.

### BACKGROUND ART LITERATURE

### Patent Literature

Patent Literature 1: Japanese Patent Laid-open No. 2022-134873
Patent Literature 2: Japanese Patent Laid-open No. 2022-156249
Patent Literature 3: Japanese Patent Laid-open No. 2021-15965

### SUMMARY OF THE INVENTION

### Problems to be Solved by the Invention

Schemes to inhibit shrinking of internal electrodes by adding to the internal electrodes a component that raises the sintering temperature, such as the one in Patent Literature 1, present a problem in that, as described in Patent Literature 2, an excessive increase in the mixing amount of the component that raises the sintering temperature in order to bring the firing shrinkage curve of the internal electrodes closer to that of the dielectric layers leads to a drop in the coverage factor of the electrodes due to a drop in the percentage content of conductive components in the internal electrodes.

Also, schemes that allow a solid solution whose main component is Ni to coexist with a metal phase different therefrom, such as those in Patent Literatures 2 and 3, require adding a large amount (generally 10% by mass or more) of a metal other than Ni to cause the different phase to precipitate, which presents a problem of an escalating electrode cost.

Accordingly, an object of the present invention is to solve the aforementioned problems and provide at low cost a multilayer ceramic capacitor with minimal discontinuity in its internal electrodes.

### Means for Solving the Problems

After conducting various studies to solve the aforementioned problems, the inventor of the present invention found that the aforementioned object could be achieved when the internal electrodes contain nickel as a main component element while also containing at least two types of additive elements selected from a group that consists of metal elements that form an alloy together with nickel, and of silicon, and eventually completed the present invention.

To be specific, an aspect of the present invention to solve the problems is a multilayer ceramic capacitor, comprising: a multilayer chip, having multiple dielectric layers formed by a dielectric ceramic, and internal electrodes respectively placed on the top and bottom faces of each of the dielectric layers, whose main component element is nickel and which further contain, by a total amount of 10% by atom or less relative to nickel, at least two types of additive elements selected from a group that consists of metal elements that form an alloy together with nickel, and of silicon, wherein a pair of extraction faces are formed in a manner facing each other and having the internal electrodes alternately extracted thereto and exposed thereon; and external electrodes that electrically connect together the internal electrodes extracted onto the extraction faces of the multilayer chip.

### Effects of the Invention

According to the present invention, a multilayer ceramic capacitor that minimizes discontinuity in internal electrodes can be provided at low cost.

### BRIEF DESCRIPTION OF THE DRAWINGS

FIG. 1 is a schematic diagram (plan view in length direction) showing the structure of a multilayer ceramic capacitor pertaining to an aspect of the present invention.

FIG. 2 is a schematic diagram (plan view in width direction) showing the structure of a multilayer ceramic capacitor pertaining to an aspect of the present invention.

FIG. 3 is a diagram explaining an overview of measurements for determining the continuity ratio of the internal electrodes.

FIG. 4 is a diagram showing a position (colored part) inside an internal electrode in the vicinity of its interface with a dielectric layer, determined with respect to the multilayer ceramic capacitor pertaining to Example 3.

FIG. 5 is a diagram showing a distribution of Fe concentrations inside an internal electrode in the vicinity of its interface with a dielectric layer (colored part), and in regions adjacent thereto, with respect to the multilayer ceramic capacitor pertaining to Example 3.

### MODE FOR CARRYING OUT THE INVENTION

The constitutions as well as operations and effects of the present invention are explained below, together with the technical concepts, by referring to the drawings. It should be noted, however, that the mechanisms of operations include estimations, and whether they are correct or incorrect does not limit the present invention.

### [Multilayer Ceramic Capacitor]

The multilayer ceramic capacitor 100 pertaining to an aspect of the present invention (hereinafter also referred to simply as “multilayer ceramic capacitor pertaining to this aspect”) has a rectangular solid shape and comprises pairs of faces each running at right angles with one of three axes that are orthogonal to one another, i.e., an L-axis representing the length direction, a W-axis representing the width direction, and a T-axis representing the height direction. The rectangular solid is not limited to a mathematically defined rectangular solid and only needs to be a shape that is recognized as a rectangular solid when its entire shape is observed. Accordingly, a shape whose ridge parts and corner parts are rounded, shape whose ridge parts consist of curved lines, or shape whose constituent faces are curved faces having small radii of curvature, also fulfills the conditions of a rectangular solid in the present disclosure. The dimension in length (L) direction, dimension in width (W) direction, and dimension in height (T) direction, of the ceramic capacitor 100 can each independently take an arbitrary value, and their magnitude relation is not limited, either. For example, “(Dimension in L direction)>(Dimension in W direction)≥(Dimension in T direction,” or “(Dimension in W direction)>(Dimension in L direction),” or “(Dimension in T direction)>(Dimension in W direction),” may be satisfied.

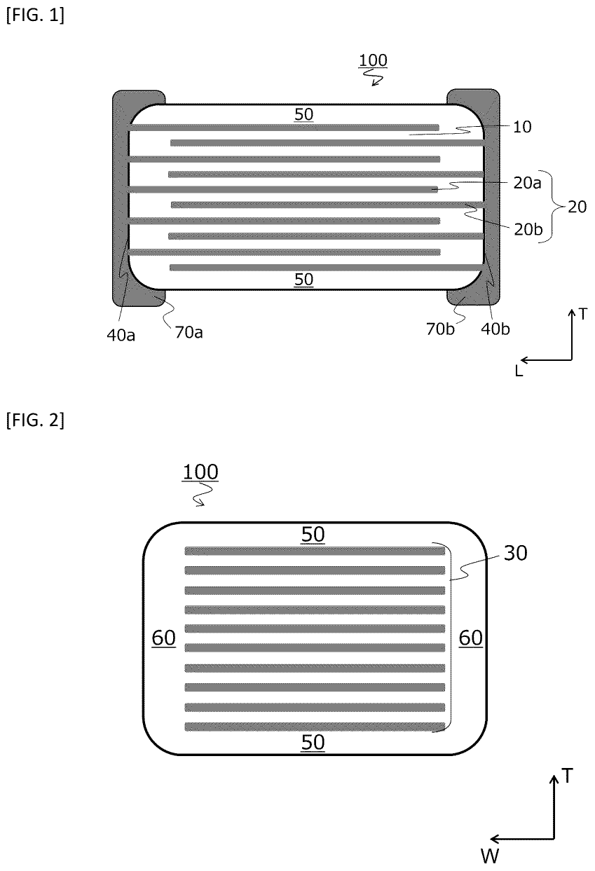

The multilayer ceramic capacitor 100 pertaining to this aspect comprises, as shown in FIG. 1 (LT cross-section) and FIG. 2 (WT cross-section) schematically illustrating its cross-sectional views, a multilayer chip 30 having multiple dielectric layers 10 formed by a dielectric ceramic, and internal electrode layers 20 respectively placed on the top and bottom faces of each of the dielectric layers 10 representing faces crossing at right angles with the lamination direction (T direction). Formed on the multilayer chip 30 are an extraction face 40a to and on which the internal electrodes 20a are extracted in length direction (L direction) and exposed, and an extraction face 40b to and on which the internal electrodes 20b are extracted in length direction (L direction) and exposed. To be specific, the internal electrodes 20 are alternately extracted to and exposed on each of the extraction faces 40a, 40b. The multilayer chip 30 may be one having cover parts 50 formed on its top and bottom faces in the lamination direction. Also, the multilayer chip 30 may be one having side margin parts 60 formed on its side faces crossing at right angles with the extraction faces 40a, 40b as well as top and bottom faces. The multilayer ceramic capacitor pertaining to this aspect comprises external electrodes 70a, 70b that electrically connect together the internal electrodes 20a and internal electrodes 20b extracted onto the extraction face 40a and extraction face 40b, respectively. It should be noted that the multilayer ceramic capacitor 100 pertaining to this aspect may comprise terminal electrodes (not illustrated) that are electrically connected to the external electrodes 70a, 70b, respectively, to be electrically connected to an external circuit when the multilayer ceramic capacitor is mounted on a circuit board.

Each part constituting the multilayer ceramic capacitor 100 pertaining to this aspect is described in detail below.

### (Dielectric Layers)

The dielectric layers 10 are formed by a dielectric ceramic. The compositional makeup of the dielectric ceramic is not specifically limited and only needs to be selected as deemed appropriate according to the properties required of the multilayer ceramic capacitor. Examples of preferred compositional makeups of the dielectric ceramic include those whose main component is barium titanate (BaTiO₃). The dielectric layers 10 may contain additive elements listed below. Examples of additive elements include at least one type selected from Mo, Nb, Ta, W, Mg, Mn, V, Cr, rare earth elements (Y, Sm, Eu, Gd, Tb, Dy, Ho, Er, Tm, and Yb), as well as Co, Ni, Li, B, Na, K, and Si. An additive element may be contained as a single element, or it may be contained in the form of an oxide, nitride, carbide, or other compound. Also, an additive element may be present in a state of solid solution in the barium titanate being the main component, or it may be forming a different phase with the element constituting the main component or other additive element.

### (Internal Electrodes)

The internal electrodes 20 contain nickel (Ni) as a main component element. Here, a “main component element” in the Specification means an element having the largest content expressed in atomic percentage (% by atom). When the internal electrodes 20 are those whose main component element is nickel, the use amounts of expensive materials can be reduced to lower the manufacturing cost of the multilayer ceramic capacitor.

The internal electrodes 20 contain, in addition to nickel being the main component element, at least two types of additive elements selected from a group that consists of metal elements that form an alloy together with nickel, and of silicone. Here, “metal elements that form an alloy together with nickel” in the Specification means metal elements that form a solid solution or intermetallic compound in a binary equilibrium phase diagram with nickel.

When the internal electrodes 20 contain two or more types of additive elements in addition to nickel, discontinuity in the internal electrodes can be inhibited by a small amount of additive elements. Presumably this is because the presence of more types of additive elements promotes solid-solution strengthening of the solid solution in nickel (γ phase) or causes the intermetallic compound (γ′ phase) to precipitate and trigger precipitation strengthening, thereby preventing deformation or fracture of the internal electrodes that would otherwise occur due to thermal stress during firing.

Also, it is assumed that one or more of (a) to (c) below is/are a reason(s) why discontinuity in the internal electrodes is inhibited:
(a) The additive elements together form alloys, thereby inhibiting their diffusion to the dielectric layers 10.
(b) The additive elements form a solid solution in Ni, thereby lowering the coefficient of thermal expansion or surface free energy to inhibit spheroidization of the internal electrodes during firing.
(c) The additive elements at least partially segregate in the vicinity of the interfaces with the dielectric layers 10, thereby inhibiting the diffusion of the internal electrode components to the dielectric layers 10.

The types of additive elements are not specifically limited, but preferably at least two types of elements that form the γ′ phase in nickel-based alloys are contained from the viewpoint of markedly inhibiting discontinuity in the internal electrodes 20. Why discontinuity in the internal electrodes is markedly inhibited when the internal electrodes 20 contain at least two types of elements that form the γ′ phase in nickel-based alloys, is not clear at this time. Possible mechanisms of operations include one whereby the γ′ phase generates at a concentration lower than when only a single element that forms the γ′ phase is contained, which leads to precipitation strengthening of the internal electrodes 20 and inhibits their deformation during firing.

Examples of elements that form the γ′ phase in nickel-based alloys include metal elements such as aluminum (Al), titanium (Ti), vanadium (V), niobium (Nb), and tantalum (Ta). Additionally, silicon (Si), while not a metal element, is also known as an element that forms the γ′ phase in nickel-based alloys. Of these, combining Al and Si produces a particularly marked effect in inhibiting discontinuity in the internal electrodes.

Also, from the viewpoint of making the multilayer ceramic capacitor 100 one having a long service life, preferably at least one type of element that forms the γ′ phase in nickel-based alloys, and at least one type of element that forms the γ phase in nickel-based alloys and whose standard electrode potential is smaller than that of nickel, are contained as the additive elements. Why the service life is extended when the internal electrodes 20 contain at least one type of element that forms the γ′ phase in nickel-based alloys, and at least one type of element that forms the γ phase in nickel-based alloys and whose standard electrode potential is smaller than that of nickel, is not clear at this time; however, the following is assumed as a potential mechanism of operation. First, during the firing of the laminated body in a reducing atmosphere as described later, the presence of the element that forms the γ′ phase causes the element that forms the γ phase to selectively form a solid solution with nickel. In this solid solution, the nickel atoms and the atoms of the element that forms the γ phase are in a state of having mutually and freely exchangeable positions in the crystal lattice. When the reoxidation process described later is performed in this state, the element that forms the γ phase is preferentially oxidized in the vicinity of the interfaces with the dielectric layers 10 owing to the fact that the standard electrode potential of the element that forms the γ phase is lower than that of nickel. The driving force of this preferential oxidation, coupled with the case of atomic position exchange of atoms in the crystal lattice, causes the element that forms the γ phase to diffuse to the vicinity of the interfaces with the dielectric layers 10. This diffusion increases the concentration of the element that forms the γ phase in the vicinity of the interfaces and thus electrical barriers are formed, thereby preventing, over an extended period of time, failures that would otherwise occur as a result of the dielectric layers 10 becoming conductive. The above mechanism of operation also aligns with the fact that, in “Examples” below, the concentration of the element that forms the γ phase (Fe) in the vicinity of the interface with the dielectric layer 10 became higher than in other regions. Preferably inside the internal electrode layers 20 in the vicinity of their interfaces with the dielectric layers 10, the total concentration of the elements that form the γ phase in nickel-based alloys and whose standard electrode potential is smaller than that of the nickel is 1.0% by atom or higher, in that a multilayer ceramic capacitor having a longer service life can be obtained.

For the element that forms the γ′ phase in nickel-based alloys, those mentioned above can be used. Of these, Al is preferred in that a longer service life can be obtained.

Examples of elements that form the γ phase in nickel-based alloys and whose standard electrode potential is smaller than that of nickel include iron (Fe), chromium (Cr), manganese (Mn), and cobalt (Co). Of these, Fe is preferred in that a longer service life can be obtained.

Additionally, from the viewpoint of inhibiting discontinuity in the internal electrodes 20 while also achieving a long service life, both at high levels, preferably at least two types of elements that form the γ′ phase in nickel-based alloys, and at least one type of element that forms the γ phase in nickel-based alloys and whose standard electrode potential is smaller than that of nickel, are contained as the additive elements. Why discontinuity in the internal electrodes 20 is markedly inhibited while the service life is extended when the internal electrodes 20 contain at least two types of elements that form the γ′ phase in nickel-based alloys, and at least one type of element that forms the γ phase in nickel-based alloys and whose standard electrode potential is smaller than that of nickel, is not clear at this time. Possible mechanisms of operations include a synergistic manifestation of the aforementioned effect of containing two or more types of elements that form the γ′ phase, and the effect of containing, in addition to the elements that form the γ′ phase, an element that forms the γ phase in nickel-based alloys and whose standard electrode potential is smaller than that of nickel. In this case, the combination of individual elements only needs to be selected as deemed appropriate from among the various types of elements mentioned above; however, combining Al and Si as the elements that form the γ′ phase and Fe as the element that forms the γ phase is preferred in that it inhibits discontinuity in the internal electrodes 20 while also achieving a long service life, both at extremely high levels.

The additive elements amount to 10% by atom or less in total relative to nickel. When the amount of additive elements is equal to or less than this upper-limit value, the material cost of the internal electrodes can be reduced to lower the manufacturing cost of the multilayer ceramic capacitor. From the viewpoint of further reducing the material cost of the internal electrodes, the additive elements amount to preferably 8% by atom or less in total relative to nickel, or more preferably 5% by atom or less in total relative to nickel. While the lower-limit value of the amount of the additive elements is not specifically limited, they amount to preferably 0.1% by atom or more in total relative to nickel, or more preferably 0.5% by atom or more in total relative to nickel, or yet more preferably 1% by atom or more in total relative to nickel, in that a marked effect of inhibiting discontinuity in the internal electrodes will be achieved. If elements that form the γ′ phase in nickel-based alloys are contained as additive elements, their content, with respect to each element, is preferably 0.1% by atom or more relative to nickel. This means that, if multiple types of elements that form the γ′ phase in nickel-based alloys are contained, the content per element is 0.1% by atom or more relative to nickel.

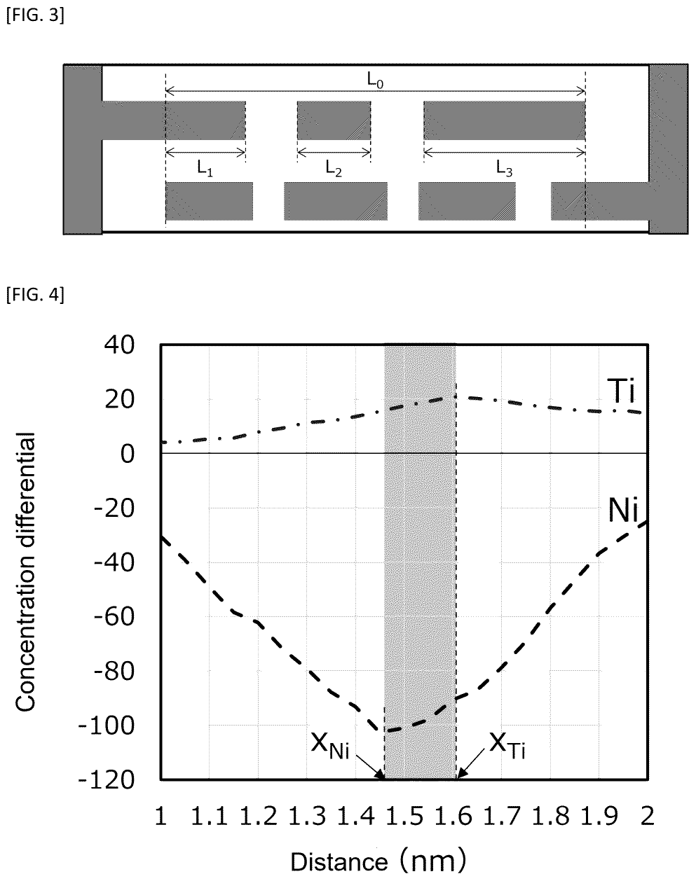

Here, the degree to which discontinuity in the internal electrodes 20 is inhibited is evaluated by the continuity ratio determined by the procedure below. First, the multilayer ceramic capacitor 100 is cut, polished, or processed by other means to expose a cross-section (LT cross-section) crossing at right angles with both the extraction faces 40a, 40b and allowing the internal electrodes 20 to be observed in it. Next, the exposed cross-section is observed with a laser microscope or scanning electron microscope (SEM) to select an arbitrary internal electrode 20 recognized near the center part in lamination direction, as a target internal electrode for measurement. Next, a micrograph of the capacitance forming part, or specifically part overlapping with other adjacent internal electrode as viewed from the lamination direction, of the target internal electrode for measurement is analyzed by image analysis software to calculate each of the lengths L₁, L₂, L₃, . . . , of the locations where the internal electrode 20 is continuous, and obtain their total sum as the continuous length of the internal electrode, as shown in FIG. 3. Next, the same image analysis software is used to calculate the total length L₀ of the target internal electrode for measurement including the discontinuous locations. Next, the percentage of the continuous length of the internal electrode to the total length L₀, (L₁+L₂+L₃+ . . . )/L₀×100, is calculated. Next, the aforementioned steps from selecting a target internal electrode for measurement to calculating the percentage are performed for five different internal electrodes, and the average value of the percentages is used as the continuity ratio of the internal electrodes 20. The higher this continuity ratio, the greater the degree to which discontinuity in the internal electrodes 20 is inhibited in the multilayer ceramic capacitor 100.

Also, with respect to an internal electrode 20, the procedure below is used to confirm that the concentration of the element that forms the γ phase in the vicinity of its interface with a dielectric layer 10 is higher than in other regions. First, a thin specimen of 50 to 100 nm in thickness is sliced along a plane passing near the center part in width direction of the multilayer ceramic capacitor 100 and crossing at right angles with both the extraction faces 40a, 40b. The slicing uses a focused ion beam (FIB) device. Next, carbon vapor is deposited on the sliced thin specimen cross-section for use as a measurement specimen. Next, the measurement specimen is observed with a scanning transmission electron microscope (STEM) equipped with an energy-dispersive X-ray spectroscopy (EDS) detector, to specify an interface between an internal electrode 20 and a dielectric layer 10 based on a difference in contrast (brightness). In a STEM image, an internal electrode 20 is observed as a bright (whitish) area, while a dielectric layer 10 is observed as a dark (blackish) area, so an interface between the two can be specified with case. Next, line analysis is performed based on EDS along a line segment having a length of 30 to 50 nm and crossing roughly at right angles with the interface near its midpoint. The EDS measurement conditions are set to 200 kV of acceleration voltage, 1.0 nm of electron beam diameter, and 20 minutes of measurement time per measurement point. Also, measurement is repeated five times or more per measurement point, and the average value of the characteristic X-ray intensities obtained of each element is used as the characteristic X-ray intensity of each element at the measurement point. Next, for each measurement point, the characteristic X-ray intensity obtained of each element is corrected by considering the atomic number effect, absorption effect, and fluorescence excitation effect (ZAF correction), to calculate the ratios of elements at each measurement point as atomic percentages. Next, based on the calculated atomic percentage of each element, the concentration of Ni, concentration of Ti, and total concentration of the elements that form the γ phase are plotted against the measurement positions, respectively, to create graphs. When doing this, the end point of the measured line segment on the internal electrode 20 side is set as the origin. Next, on the atomic percentage graph of Ni and atomic percentage graph of Ti, a differential coefficient at each measurement position is obtained and the results are plotted against the positions to create a differential coefficient graph of Ni concentration and a differential coefficient graph of Ti concentration. Next, from the graphs obtained, the position xxi at which the differential coefficient of Ni concentration takes the smallest value, and position X_{Ti} at which the differential coefficient of Ti concentration takes the largest value, are obtained and the region between X_{Ni} and X_{Ti} is defined as the vicinity, inside the internal electrode 20, of its interface with the dielectric layer 10. Next, in the graph of the total concentration of the elements that form the γ phase, a presence of a position at which the total concentration takes the largest value in the region defined as being the vicinity of the interface, determines that the concentration of the elements that form the γ phase in the vicinity of the interface with the dielectric layer 10 is higher than in other regions for this internal electrode 20. Then, the largest value of total concentration is used as the concentration (atomic percentage) of the elements that form the γ phase in the vicinity of the interface with the dielectric layer 10.

Additionally, the amount of additive elements in the internal electrode 20 is determined by the procedure below. First, from the aforementioned EDS-based line analysis result, the ratios of Ni and the additive elements at each measurement point are calculated as atomic percentages. Next, based on the atomic percentages obtained, the atomic percentage of each of the additive elements relative to Ni at each measurement point is calculated. Next, for the measurement points positioned inside the internal electrode 20 in the vicinity of its interface with the dielectric layer 10, and measurement points positioned on the origin side of this region, as determined from the aforementioned differential coefficient graph of Ni concentration and differential coefficient graph of Ti concentration, the total sum of the calculated atomic percentages of the additive elements relative to Ni is divided by the number of measurement points to calculate the average value, and this is used as the amount of additive elements in the internal electrode 20.

The thickness, or specifically dimension in lamination direction (T direction), of the internal electrodes 20 is not specifically limited; however, from the viewpoint of increasing the number of laminated layers in a multilayer chip 30 of a fixed dimension in lamination direction to obtain a multilayer ceramic capacitor 100 with a greater capacitance, this thickness is preferably 1.0 μm or less, or more preferably 0.5 μm or less, or yet more preferably 0.3 μm or less. The multilayer ceramic capacitor 100 having such thin internal electrodes 20 demonstrates a more marked effect of preventing a drop in capacitance due to the aforementioned discontinuity inhibiting countermeasure concerning the internal electrodes 20.

### (External Electrodes)

The external electrodes 70a, 70b are provided on the extraction faces 40a, 40b of the multilayer chip 30 and electrically connect together the internal electrodes 20a, and internal electrodes 20b, extracted to each of the faces. The external electrodes 70a, 70b shown in FIG. 1 extend out from the extraction faces 40a, 40b of the multilayer chip 30 to the top and bottom faces as well as side faces; however, the shape of the external electrodes 70a, 70b is not limited to the foregoing.

The material for the external electrodes 70a, 70b is not limited so long as it is conductive. Examples of the material include copper (Cu), nickel (Ni), tin (Sn), palladium (Pd), platinum (Pt), silver (Ag), gold (Au), and other metals, as well as alloys having any one of the foregoing as a main component element.

### (Cover Parts and Side Margin Parts)

The cover parts 50 and side margin parts 60 function as protective parts for protecting the dielectric layers 10 and internal electrodes 20.

The material for the cover parts 50 and side margin parts 60 is not limited so long as it has high electrical insulating property and low permeability against moisture content and other degradation factors. From the viewpoints of achieving uniform shrinkage during firing when the multilayer ceramic capacitor 100 is manufactured, of relieving the internal stress in the multilayer ceramic capacitor 100, and the like, preferably the material for the cover parts 50 and side margin parts 60 is the same as the dielectric ceramic by which the dielectric layers 10 are formed.

### [Method for Manufacturing Multilayer Ceramic Capacitor]

The multilayer ceramic capacitor pertaining to this aspect is manufactured, for example, by: preparing green sheets that contain a powder of dielectric ceramic composition and a binder; forming internal electrode patterns having a prescribed compositional makeup and shapes on the green sheets by means of sputtering; stacking a prescribed number of the green sheets on which the internal electrode patterns have been formed and pressure-bonding them to obtain a formed green sheet; removing the binder from the formed green sheet and then firing it to obtain a multilayer chip; and depositing a conductive paste on the extraction faces of the multilayer chip and then baking the paste to form external electrodes. The external electrodes may also be formed by depositing a conductive paste on the extraction faces of the precursor to multilayer chip after removing the binder and then firing the paste simultaneously with the multilayer chip. Each operation is described in detail below.

### (Preparation of Dielectric Ceramic Composition Powder)

The powder of dielectric ceramic composition are obtained, for example, by mixing various material powders containing the constituent elements thereof at prescribed ratios and pre-firing (calcining) the mixture. When mixing the various material powders at the prescribed ratios, the aforementioned additive elements, sintering auxiliary agents, and various other additives may also be added, or these various additives may be added to the calcined powder.

The method for mixing the material powders is not specifically limited so long as the respective powders are mixed homogeneously while preventing impurities from mixing in, and either dry mixing or wet-mixing may be adopted. If wet-mixing using a ball mill is adopted as the mixing method, it suffices to agitate the mixture for 8 to 60 hours or so using a ball mill in which partially stabilized zirconia (PSZ) balls are used and the dispersion medium is ethanol or other organic solvent or water and then evaporate and dry the dispersion medium.

The calcining conditions of the mixed material powder are not specifically limited so long as the aforementioned various material powders react with one another to provide a prescribed dielectric ceramic composition. An example is 1 to 10 hours of firing at a temperature of 800° C. to 1100° C. in the air. The calcined powder may be directly applied on the green sheets, but preferably it is pulverized using a ball mill, stamp mill, or the like, in that doing so achieves a uniform slurry, and consequently smooth green sheets, and also boosts the sintering property.

It should be noted that, if a commercially available dielectric ceramic composition powder can be utilized, the subsequent operations may be performed on this powder by skipping the aforementioned mixing and calcining of the material powders.

### (Production of Green Sheets)

The green sheets containing a powder of dielectric ceramic composition and a binder are obtained, for example, by mixing the aforementioned powder of dielectric ceramic composition with a binder and a dispersion medium to prepare a slurry and forming the slurry into sheets.

For the binder, one that can retain the shape of the green sheets described below, while allowing carbon, or the like, to volatilize without leaving any residues as a result of the firing or prior binder removal process, is used. Examples of binders that can be used include polyvinyl alcohol-based, polyvinyl butyral-based, cellulose-based, urethane-based, and vinyl acetate-based binders. The use amount of the binder is not specifically limited, either; since the binder will be removed in a subsequent process, however, preferably its use amount is minimized in the interest of lower material cost to the extent that desired compactibility and shape retainability will be achieved.

For the dispersion medium, one that does not cause the calcined powder and binder to aggregate and can be easily removed by means of volatilization, or the like, following the forming of green sheets as described below, is used. Examples of dispersion media that can be used include water, alcohol-based solvents, and the like.

Dispersants, plasticizers, thickening agents, and other components for adjusting the properties of the slurry may be added to the slurry.

The method for mixing the above mixed powder with the binder and dispersion medium is not specifically limited so long as the respective components are mixed homogeneously while preventing impurities from mixing in. Ball-mill mixing is mentioned as an example.

For the method by which to form the prepared slurry into sheets to obtain green sheets, the doctor blade method or other commonly used method can be adopted.

### (Formation of Internal Electrode Patterns)

Internal electrode patterns can be formed by sputtering the various elements on the green sheets in a manner achieving a prescribed compositional makeup and shapes. The sputtering may be one that uses a single sputtering target having the same composition makeup as the internal electrodes to be formed, or one that involves use of multiple sputtering targets of different compositional makeup and controlling of the conditions so that the films to be formed on the green sheets will have a prescribed compositional makeup.

### (Production of Formed Green Sheet)

The formed green sheet is obtained, for example, by stacking a prescribed number of the green sheets on which the internal electrode patterns have been formed and pressure-bonding the green sheets together. It suffices that the stacking and pressure-bonding are performed by any commonly used methods, and the methods that can be adopted include one whereby the stacked green sheets are pressed together in the lamination direction under heat to be thermally bonded by the action of the binder.

At the time of stacking and pressure-bonding, green sheets that will become cover parts in the resulting multilayer ceramic capacitor may be added to the two end parts in the lamination direction. In this case, the green sheets to be added may have the same compositional makeup as the green sheets on which the internal electrode patterns have been formed, or they may have a compositional makeup different therefrom. From the viewpoint of aligning the shrinkage ratio during firing, preferably the compositional makeup of the green sheets to be added is the same as, or similar to, the green sheets on which the aforementioned internal electrode patterns have been placed.

### (Production of Multilayer Chip)

The multilayer chip is obtained by firing the aforementioned formed green sheet. The binder may be removed from the formed green sheet prior to firing. In this case, the binder removal and firing may be performed successively using the same firing device. The conditions for binder removal and firing only need to be set as deemed appropriate according to the volatilization temperature and content of the binder, sintering property of the dielectric ceramic composition, heat resistance and oxidation resistance of the metals contained in the internal electrode paste, and the like. Examples of conditions under which to remove the binder include 5 to 20 hours at a temperature of 200° C. to 500° C. in a nitrogen (N₂) atmosphere. If external electrodes are to be formed before firing, the external electrodes are formed in this stage as described below. Also, examples of firing conditions include 10 minutes to 2 hours at 1000° C. to 1400° C. in a reducing atmosphere of mixed nitrogen (N₂) and water vapor (H₂O). After firing, a reoxidation process in which the temperature is maintained at 600° C. to 1000° C. in a nitrogen (N₂) gas atmosphere or low-oxygen atmosphere may be performed. It should be noted that, if multiple multilayer chips are to be obtained from one formed green sheet, the formed green sheet may be divided into any number of blocks prior to firing.

### (Formation of External Electrodes)

A conductive paste is deposited on the extraction faces of the fired multilayer chip, and then baked, to form external electrodes and thereby complete a multilayer ceramic capacitor. The methods for depositing the conductive paste include printing, dipping, and the like.

### EXAMPLES

The present invention is explained more specifically below using examples; however, the present invention is not limited to these examples.

### Example 1

As the powder of dielectric ceramic composition, a powder of barium titanate (BaTiO₃) to which a small amount of holmium (Ho) had been added was prepared. To this powder, a polyvinyl butyral-based binder and an alcohol-based solvent were added, followed by wet ball-mill mixing. The mixed slurry obtained was formed using a doctor blade to obtain green sheets. On these green sheets, internal electrode patterns of a compositional makeup comprising 0.77% by atom of Al and 0.28% by atom of Si relative to Ni were formed by means of sputtering. Here, both Al and Si are elements that form the γ′ phase in nickel-based alloys. The internal electrode-formed green sheets were stacked to 100 layers and pressure-bonded by pressing under heat, to obtain a laminated body. This laminated body was separated into individual pieces, which were then heated in a nitrogen atmosphere to undergo a binder removal process. The binder-removed laminated bodies were fired for 2 hours at 1200° C. in a so-called nitrogen-water vapor atmosphere consisting of a reducing gas of hydrogen-containing nitrogen to which water vapor had been introduced, followed by a cooldown during which the temperature was maintained temporarily at 700° C. in a nitrogen atmosphere and then lowered to near room temperature, to obtain multilayer chips. The extraction faces of each of these multilayer chips were dipped in a conductive paste containing copper and then baked to form external electrodes, and thus a multilayer ceramic capacitor pertaining to Example 1 was obtained. The multilayer ceramic capacitor obtained was such that a face of its multilayer chip vertical to the lamination direction had a rectangular shape of 1.0 mm×0.5 mm and the dielectric layers had a thickness of 1.3 μm.

### Example 2

A multilayer ceramic capacitor pertaining to Example 2 was obtained in the same manner as in Example 1, except that the compositional makeup of the internal electrode patterns was changed to one comprising 0.85% by atom of Al and 1.72% by atom of Fe relative to Ni. Here, Al is an element that forms the γ′ phase in nickel-based alloys, while Fe is an element that forms the γ phase in nickel-based alloys and whose standard electrode potential is smaller than that of nickel.

### Example 3

A multilayer ceramic capacitor pertaining to Example 3 was obtained in the same manner as in Example 1, except that the compositional makeup of the internal electrode patterns was changed to one comprising 0.90% by atom of Al, 1.00% by atom of Fe, and 0.30% by atom of Si relative to Ni.

### Comparative Example 1

A multilayer ceramic capacitor pertaining to Comparative Example 1 was obtained in the same manner as in Example 1, except that the compositional makeup of the internal electrode patterns was changed to one effectively comprising Ni alone.

### Comparative Example 2

A multilayer ceramic capacitor pertaining to Comparative Example 2 was obtained in the same manner as in Example 1, except that the compositional makeup of the internal electrode patterns was changed to one comprising 0.40% by atom of Al relative to Ni.

### Comparative Example 3

A multilayer ceramic capacitor pertaining to Comparative Example 3 was obtained in the same manner as in Example 1, except that the compositional makeup of the internal electrode patterns was changed to one comprising 0.30% by atom of Si relative to Ni.

### [Evaluation of Multilayer Ceramic Capacitor]

### (Continuity Ratio of Internal Electrodes)

For each of the multilayer ceramic capacitors obtained, the continuity ratio of the internal electrodes was determined according to the method described above.

### (Reliability)

For each of the multilayer ceramic capacitors pertaining to each of the Examples and Comparative Example 1, 50 test samples were prepared and each test sample was impressed with a direct-current voltage of 18 V at 125° C. Then, the time it took for a half of the test samples to fail was used as the mean time to failure (MTTF).

Table 1 shows a summary of the types and amounts of the additive elements in the internal electrodes, continuity ratio of the internal electrodes, and mean time to failure, with respect to each of the multilayer ceramic capacitors obtained in the Examples and Comparative Examples.

TABLE 1

| | Types and | Continuity ratio | Mean time |
|---|---|---|---|
| | amounts of | of internal | to failure |
| | additive elements | electrodes (%) | (min) |
| Example 1 | Al 0.77 at % | 83 | 1047 |
| | Si 0.28 at % | | |
| Example 2 | Al 0.85 at % | 71 | 3211 |
| | Fe 1.72 at % | | |
| Example 3 | Al 0.90 at % | 92 | 4713 |
| | Fe 1.00 at % | | |
| | Si 0.30 at % | | |
| Comparative Example 1 | — | 57 | 1156 |
| Comparative Example 2 | Al 0.40 at % | 54 | — |
| Comparative Example 3 | Si 0.30 at % | 60 | — |

From Table 1, clearly the continuity ratio of the internal electrodes is higher with the multilayer ceramic capacitors whose internal electrodes use nickel as a main component element and also contain at least two types of additive elements selected from metal elements that form an alloy together with nickel, and from silicon, compared to those whose internal electrodes do not contain additive elements or whose internal electrodes contain only one type of additive element.

Additionally, from a comparison of Examples 1, 3 and Example 2 in Table 1, clearly the continuity ratio of the internal electrodes is markedly higher with the multilayer ceramic capacitors whose internal electrodes contain as additive elements at least two types of elements that form the γ′ phase in nickel-based alloys, compared to the one whose internal electrodes contain only one type of such element.

Furthermore, from a comparison of Examples 2, 3 and Example 1 in Table 1, clearly the multilayer ceramic capacitors whose internal electrodes contain as additive elements at least one type of element that forms the γ′ phase in nickel-based alloys, and at least one type of element that forms the γ phase in nickel-based alloys and whose standard electrode potential is smaller than that of nickel, has a longer service life compared to the one whose internal electrodes do not contain the foregoing element that forms the γ phase.

### (Confirmation of Element Distribution in Internal Electrodes)

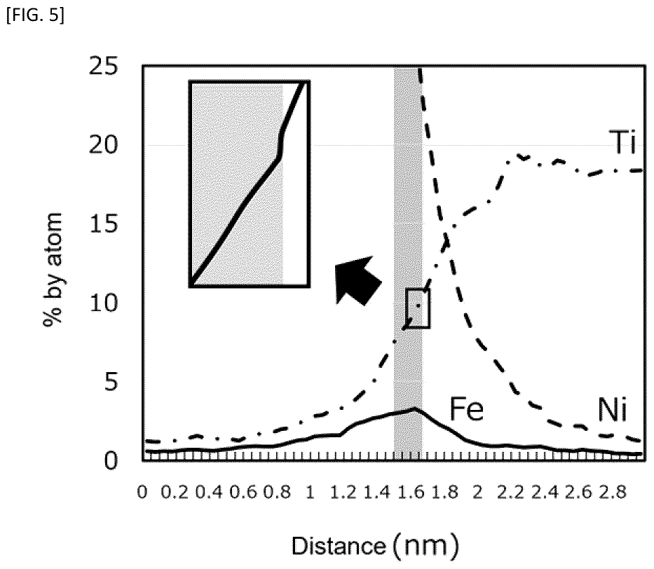

For the multilayer ceramic capacitor pertaining to Example 3, the aforementioned procedure was followed to confirm that the concentration of the element that forms the γ phase was higher inside an internal electrode in the vicinity of its interfaces with a dielectric layer. As a result, the region shown in FIG. 4 (a region in gray from X_{Ni} to X_{Ti}) was determined as the vicinity, inside the internal electrode, of its interface with the dielectric layer, and the concentration of Fe being the element that forms the γ phase was confirmed higher in this vicinity of the interface, as shown in FIG. 5. This result suggests a possibility that the element that forms the γ phase, present at a high concentration in the vicinity of the interfaces with the dielectric layers, contributes to extending the service life of the multilayer ceramic capacitor. It should be noted that in FIG. 5, although it may not be easily observed from the dash-dot broken line indicating the concentration of Ti, the solid line in the enlarged view of the region in gray in FIG. 5 shows that the tangent slope of Ti concentration changes in the region in gray increases toward X_{Ti} (the right end point), and it becomes highest at X_{Ti} as shown by the dash-dot broken line indicating differential coefficient values of Ti concentration changes.

The following arts are also disclosed in the Specification.

### APPENDANT 1

A multilayer ceramic capacitor, comprising:
a multilayer chip, having:
multiple dielectric layers formed by a dielectric ceramic, and
internal electrodes respectively placed on the top and bottom faces of each of the dielectric layers, whose main component element is nickel and which further contain, by a total amount of more than 0% and no more than 10% by atom relative to nickel, at least two additive elements selected from a group that consists of metal elements that form an alloy together with nickel, and of silicon,
wherein a pair of extraction faces are formed in a manner facing each other and having the internal electrodes alternately extracted to and exposed on the respective extraction faces; and
external electrodes that electrically connect together the internal electrodes extracted onto the respective extraction faces of the multilayer chip.

### APPENDANT 2

The multilayer ceramic capacitor according to (Appendant 1), wherein the internal electrodes contain at least two elements that form a γ′ phase in nickel-based alloys as the additive elements.

### APPENDANT 3

The multilayer ceramic capacitor according to (Appendant 1), wherein the internal electrodes contain at least one type of element that forms the γ′ phase in nickel-based alloys, and at least one type of element that forms the γ phase in nickel-based alloys and whose standard electrode potential is smaller than that of nickel, as the additive elements.

### APPENDANT 4

The multilayer ceramic capacitor according to (Appendant 2), wherein the internal electrodes further contain element(s) that form(s) a γ phase in nickel-based alloys and whose standard electrode potential(s) is/are smaller than that of nickel, as the additive element.

### APPENDANT 5

The multilayer ceramic capacitor according to (Appendant 3) or (Appendant 4), wherein the internal electrodes have an area in a vicinity of their interfaces with the dielectric layers where concentration(s) of the element(s) that form(s) the γ phase in nickel-based alloys is/are higher than the concentration(s) in a region of the internal electrodes other than the area.

### APPENDANT 6

The multilayer ceramic capacitor according to (Appendant 5), wherein the total concentration of the element(s) that form(s) the γ phase in nickel-based alloys inside the internal electrodes in the vicinity of their interfaces with the dielectric layers is 1.0% by atom or higher.

### APPENDANT 7

The multilayer ceramic capacitor according to any one of (Appendant 2) to (Appendant 6), wherein the element(s) that form(s) the γ′-phase in nickel-based alloys is/are selected from a group that consists of aluminum, titanium, vanadium, niobium, tantalum, and silicon.

### APPENDANT 8

The multilayer ceramic capacitor according to any one of (Appendant 2) to (Appendant 7), wherein the content of each of the element(s) that form(s) the γ′-phase in nickel-based alloys is 0.1% by atom or higher relative to nickel.

### APPENDANT 9

The multilayer ceramic capacitor according to any one of (Appendant 3) to (Appendant 6), wherein the element(s) that form(s) the γ phase in nickel-based alloys is/are selected from a group that consists of iron, chromium, manganese, and cobalt.

### APPENDANT 10

The multilayer ceramic capacitor according to (Appendant 9), wherein the element(s) that form(s) the γ′-phase in nickel-based alloys is/are selected from a group that consists of aluminum, titanium, vanadium, niobium, tantalum, and silicon.

### APPENDANT 11

The multilayer ceramic capacitor according to (Appendant 10), wherein the content of each of the element(s) that form(s) the γ′-phase in nickel-based alloys is 0.1% by atom or higher relative to nickel.

### INDUSTRIAL FIELD OF APPLICATION

According to the present invention, a multilayer ceramic capacitor with inhibited discontinuity in internal electrodes can be provided. Such multilayer ceramic capacitor can achieve a large capacitance even in a small body and is therefore useful as a high-end multilayer ceramic capacitor having high capacity and high reliability for use in onboard applications and mobile terminal applications. Also, according to a preferred mode of the present invention, a multilayer ceramic capacitor having a long service life can be provided. This also makes the present invention useful in that it can extend the service life of equipment in which the multilayer ceramic capacitor is installed.

### DESCRIPTION OF THE SYMBOLS

100 Multilayer ceramic capacitor
10 Dielectric layer
20, 20a, 20b Internal electrode
30 Multilayer chip
40a, 40b Extraction face
50 Cover part
60 Side margin part
70a, 70b External electrode

What is claimed:

1. A multilayer ceramic capacitor, comprising:
a multilayer chip, having:
multiple dielectric layers formed by a dielectric ceramic, and
internal electrodes respectively placed on top and bottom faces of each of the dielectric layers, whose main component element is nickel and which further contain, by a total amount of more than 0% and no more than 10% by atom relative to nickel, at least two additive elements selected from a group that consists of metal elements that form an alloy together with nickel, and of silicon,
wherein a pair of extraction faces are formed in a manner facing each other and having the internal electrodes alternately extracted to and exposed on the respective extraction faces; and
external electrodes that electrically connect together the internal electrodes extracted onto the respective extraction faces of the multilayer chip.

2. The multilayer ceramic capacitor according to claim 1, wherein the internal electrodes contain at least two elements that form a γ′ phase in nickel-based alloys as the additive elements.

3. The multilayer ceramic capacitor according to claim 1, wherein the internal electrodes contain at least one type of element that forms a γ′ phase in nickel-based alloys, and at least one type of element that forms a γ phase in nickel-based alloys and whose standard electrode potential is smaller than that of nickel, as the additive elements.

4. The multilayer ceramic capacitor according to claim 2, wherein the internal electrodes further contain element(s) that form(s) a γ phase in nickel-based alloys and whose standard electrode potential(s) is/are smaller than that of nickel, as the additive element.

5. The multilayer ceramic capacitor according to claim 4, wherein the internal electrodes have an area in a vicinity of their interfaces with the dielectric layers where concentration(s) of the element(s) that form(s) the γ phase in nickel-based alloys is/are higher than the concentration(s) in a region of the internal electrodes other than the area.

6. The multilayer ceramic capacitor according to claim 5, wherein a total concentration of the element(s) that form(s) the γ phase in nickel-based alloys inside the internal electrodes in the vicinity of their interfaces with the dielectric layers is 1.0% by atom or higher.

7. The multilayer ceramic capacitor according to claim 2, wherein the element(s) that form(s) the γ′-phase in nickel-based alloys is/are selected from a group that consists of aluminum, titanium, vanadium, niobium, tantalum, and silicon.

8. The multilayer ceramic capacitor according to claim 7, wherein a content of each of the element(s) that form(s) the γ′-phase in nickel-based alloys is 0.1% by atom or higher relative to nickel.

9. The multilayer ceramic capacitor according to claim 3, wherein the element(s) that form(s) the γ phase in nickel-based alloys is/are selected from a group that consists of iron, chromium, manganese, and cobalt.
